(19) United States
(12) Patent Application Publication
(10) Pub. No.: US 2008/0091637 A1
(43) Pub. Date: Apr. 17, 2008

(54) TEMPORAL ASSOCIATION BETWEEN ASSETS IN A KNOWLEDGE SYSTEM

(76) Inventors: Terry Dwain Escamilla, Lafayette, CO (US); Darren Scott Jeppson, Thornton, CO (US); Grant Douglas Miller, Superior, CO (US); Joan LaVerne Mitchell, Longmont, CO (US)

Correspondence Address: DUKE W. YEE;YEE & ASSOCIATES, P.C., P.O. BOX 802333, DALLAS, TX, 75380, US

(21) Appl. No.: 11/550,196

(22) Filed: Oct. 17, 2006

(51) Int. Cl. G06F 17/30

(52) U.S. Cl. 707/1

(57) ABSTRACT

A computer implemented method, data processing system, and computer program product for preserving temporal associations between assets located across a plurality of datastores in a network. Metadata about each asset located in the plurality of datastores is stored, wherein the metadata includes one or more time attributes of each asset. Temporal associations are created between the assets using the time attributes of each asset. The temporal associations between the assets are then stored. Responsive to receiving a request from a user to view a set of assets in the datastores, the temporal associations of the set of assets or links to associated assets may be displayed to the user.

### BACKGROUND OF THE INVENTION

1. Field of the Invention

The present invention relates generally to an improved data processing system, and in particular to a computer implemented method, data processing system, and computer program product for establishing and preserving temporal associations between assets located across a plurality of datastores.

2. Description of the Related Art

In the current art, there are several known search tools and Websites (e.g., Google®) that are used to help people locate information. When searching for information on the Web, the user may create a search query, and the results of the query are evaluated, organized, and then presented to the user. The results of a search typically comprise various assets, including documents, facts, information, or other content that match the query. However, when organizing the resulting information, it can be difficult to determine the value of each search result to the user. Currently, value is assigned to a search result based on the relative match of the search result to the search criteria, such as a textual match. Thus, assets in a search result are related by content, and the value of each asset in the result set is determined by how closely the content in the asset matches the textual criteria in the search query. Users themselves may also assign value to the search results, such as allowing a user to rate the results of the search, e.g., 4 stars out of 5. This user-assigned value informs other users that a located asset has value because other users found it to be valuable.

There are several approaches in existing Web sites that allow users to gather information. For instance, “bread crumb” trails are used in Web sites to show a user's path through the site, and hypertext and hyperlinks are used to show other assets which are related to the referenced asset. A problem with “bread crumb” trails is that they only show the user the path that particular user has taken through a Website, rather than a complete trail of information which shows all possible or even alternative paths available to the user or used by others. A problem with hypertext and hyperlinks is that while they may be used to show relationships between assets, they only show the relationships for a specific context within the asset and may not be related to the information that is being queried. In other words, the hyperlinks may follow a thread of topics identified within the asset by the asset author, but they do not follow a trail of the topic specified in the search. In addition, it can also be difficult to visualize or represent the total set of hyperlinks within an asset.

### BRIEF SUMMARY OF THE INVENTION

The illustrative embodiments provide a computer implemented method, data processing system, and computer program product for preserving temporal associations between assets located across a plurality of datastores in a network. Metadata about each asset located in the plurality of datastores is stored, wherein the metadata includes one or more time attributes of each asset. Temporal associations are created between the assets using the time attributes of each asset. The temporal associations between the assets are then stored. Responsive to receiving a request from a user to view a set of assets in the datastores, the temporal associations of the set of assets or links to associated assets may be displayed to the user.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram illustrating how temporal associations are created and stored;

FIG. 4 is a diagram illustrating an exemplary temporal path across related assets in a search result set;

FIG. 5 is a diagram illustrating an exemplary knowledge framework system in which temporal associations may be implemented;

FIG. 6 is a flowchart of a process for establishing temporal associations between assets within a knowledge network in accordance with the illustrative embodiments; and

FIG. 7 is a flowchart of a process for determining the path a user took to locate information and for researching information in accordance with the illustrative embodiments.

### DETAILED DESCRIPTION OF THE INVENTION

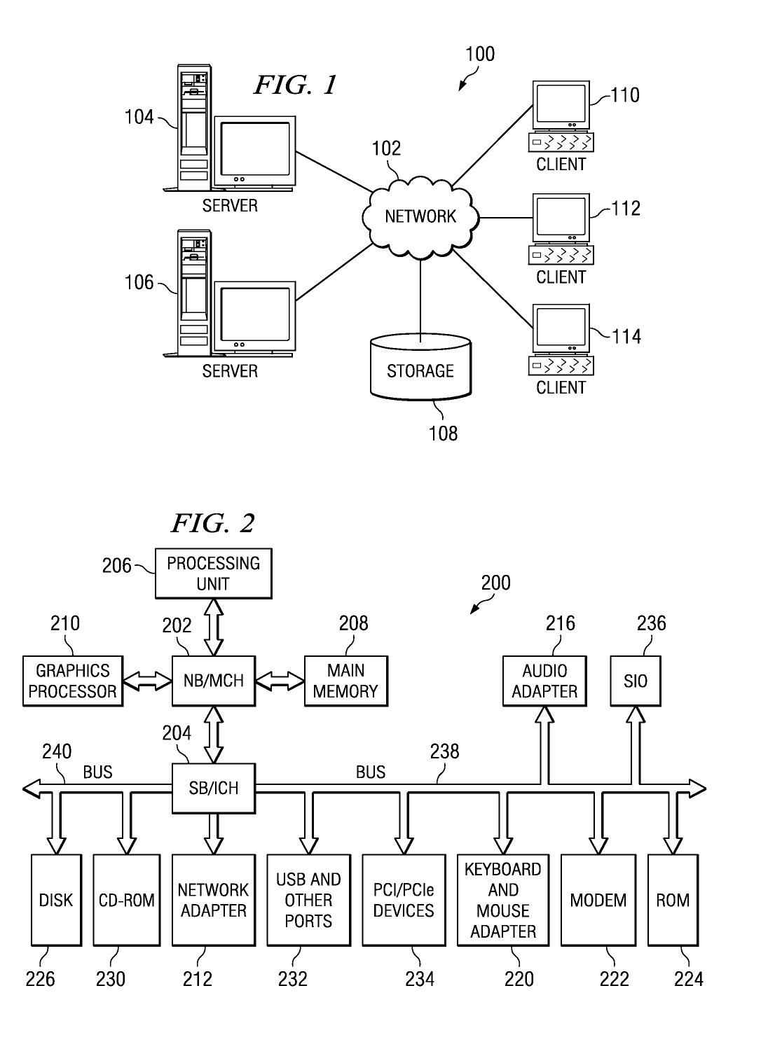

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

While current methods for generating search results may provide an output of assets which are related by content, the existing relationships in the search results lack temporal associations between the assets. An asset may include a document, Web page, or other content that match the query, including any information captured in a form that can be used for recalling information and/or knowledge. A temporal association is a time relationship between the assets. In other words, a temporal association between a set of assets is determined from the metadata which connects the assets, rather than the content within the asset itself. The time relationship may be created based on time attributes of each asset, such as time attributes generated automatically at the time an asset is created, stored, or modified.

Temporal associations give value by providing additional information about related assets in one or more datastores. This additional information includes a time relationship between the assets, as well as a “trail of information” on all available paths through the knowledge base by which a topic has evolved or the paths that were taken to find the information. Consider, for example, a researcher who is performing a literature search. The researcher may first locate relevant assets based on a search topic. The researcher may then follow references in the relevant assets to other literature in a recursive fashion, thereby disclosing a trail of information for the search query. Thus, instead of expecting the search result to only comprise objects such as documents or facts, the illustrative embodiments enable the search results to include the process whereby the result information was obtained. In other words, the search output includes the path of how the information in the search results was discovered, as the path itself has value.

A temporal association may be a static snapshot of the relationship between a set of assets at the time the association is created, or, alternatively, a dynamic association which allows the path or time to change to reflect the user's search activity. The dynamic association enables users to dynamically capture their working activities as they search for information through a network, and then compile the working activities into a path to the topic. Value is also derived from the number of nodes from start to finish along a path (depth) as well as other variables, such as the width (number of nodes at the same time) of the temporal association or the number of branches and their depth. The temporal associations may be stored as metadata for future reference, or they may be used as a one-time result.

To establish temporal associations between assets in a plurality of datastores, the process in the illustrative embodiments comprises determining if a set of assets are associated by content. Examples of assets include Web pages, PDF files, Microsoft Word® documents, PowerPoint® files, Lotus Notes® emails or database content, source code, object code, or any other knowledge documents stored in a network. Once the set of assets are determined to be related, the process identifies the time attributes of the assets in order to create the temporal associations between the assets located across a network. The time attributes are associated with an asset where it is stored, such as creation or last modification time, or in metadata stored with the asset. This process may be performed on all or some of the assets to show the temporal associations between the assets. Once the temporal associations are created, the temporal associations may be displayed to the user using graph theory or other visualization techniques, including a textual representation.

The tagging and data structures in the existing document storage and retrieval systems do not allow for temporal relationships between the assets, since the current tagging techniques merely link or associate documents together by topic. In addition, while a revision history may be kept within versions of the same document, this history relationship does not extend across different documents, or across a network. The temporal associations created using the illustrative embodiments requires that each asset has time attributes tagged within the asset directly or tagged at the location where the asset is stored. For example, the time attributes may be stored in the metadata of the asset directly, or stored in an associative layer of the network that exists at a higher abstraction layer above where the asset is stored.

In one embodiment, the tagging of temporal information may be performed using known Semantic Web constructs. However, it should be noted that any construct which allows for tagging information stored in a network may be used in place of the Semantic Web. The Semantic Web provides a common framework that allows data to be shared and reused across application, enterprise, and community boundaries. The emergence of the Semantic Web has been used to tag information in the Internet and to provide the ability for the assignment of values to hyperlinks between documents. The Semantic Web is based on the Resource Description Framework (RDF). RDF is a simple data model for referring to objects (i.e., resources) and their relationships. The Dublin Core Metadata Initiative (DCMI) provides the ability to reference objects using a standard vocabulary, including terms such as ‘references’, ‘replaces’, ‘hasPart’, ‘requires’. There are also terms/refinements for temporal values like ‘created’, ‘copyright’, ‘modified’, etc. DCMI is just one example of a vocabulary in the Semantic Web vision which provides an ability to put meaning on the links between objects in a Web. Most hyperlinks today can be seen as an unlabeled, directed graph of “this points to that”, but the Semantic Web is a process to put words on those labels. However, the current use of the Semantic Web only provides the constructs for tagging information, but does not specify how the resulting tagging may be used.

Furthermore, the temporal associations created with the illustrative embodiments also provide a learning process by which a user may identify the steps another user has taken to locate information. A user may explore another user's paths through the knowledge base, which may enable the user to move quickly through material, as well as add to the user's paths and choices. Thus, the temporal associations allow a user to determine not only what path to information the other users have taken, but also when the users located the information. In addition to the following the path that someone has taken, a user may edit and craft the trail. For example, a teacher may create a trail for students to follow through original source material. However, if the students change their mind on order, they are allowed to change the trail. Note that in such cases the original trail and the edited trail may both be preserved. The temporal associations may also be used as an aid in researching information to identify time relationships between assets.

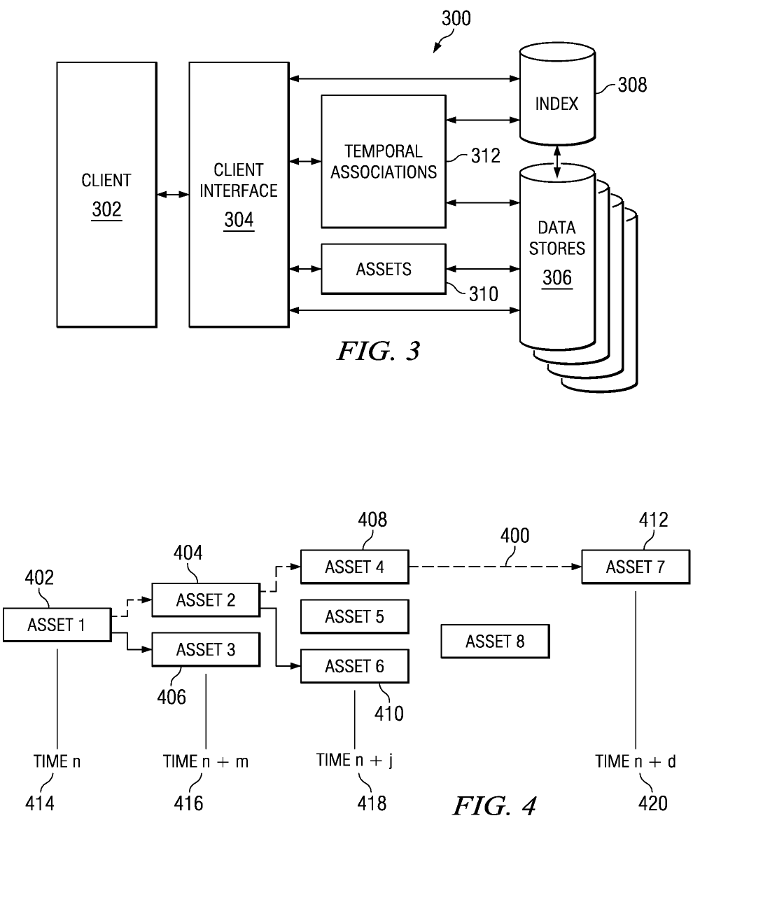

Turning now to FIG. 3, a block diagram illustrating how temporal associations may be created and stored is shown. Data processing system 300 for creating and storing temporal associations may be implemented in a network, such as network 102 in FIG. 1. The Symantec Web may provide the constructs for tagging information to allow for the creation of the temporal associations.

In this illustrative example, data processing system 300 comprises client 302, a client interface 304, a plurality of datastores 306, and index 308. Client 302 interacts with client interface 304 to initiate a search query or display the search results. The search performed by client 302 may span an entire organization, since corporate knowledge is not necessarily stored in one location and may be stored in many locations in many forms. Client interface 304 is also used to create and store assets in datastores 306. The search may also span across organizations.

Temporal attributes associated with each asset may be stored with the asset itself in datastores 306, or as associative metadata in data source index 308. This temporal attribute information for each asset may include elements such as creation time, last modification time, last viewed time, etc. A content management system may store the temporal attribute information in a separate location from the asset, such as data source index 308, and a knowledge management system may store the temporal attribute information in a same location as the asset. The temporal attributes of each asset may be described in an eXtensible Markup Language (XML) document, or any other descriptive representation that is associated with the root asset. The XML document may be stored as a separate document that is associated with the root asset, or it can be stored in user fields that are part of the asset itself. These temporal attributes may be created automatically based on the repository it is stored in, how the asset is used in a content management system, or how the asset is used in a knowledge management system.

When client 302 initiates a search query, assets matching the search criteria are located in datastores 306. These assets in the asset result set, such as assets 310, may be provided to client 302. Once the asset result set is complete, temporal associations 312 between assets 310 in the result set are derived from the time attributes stored with assets 310 in datastores 306 or stored in index 308. Temporal associations 312 are metadata, similar to tags in a markup language used for hyperlinks, which contain key information about each asset, or node, and its position relative to associated nodes. Nodes, and their tags, are grouped and identified by relationship. It should be noted, however, that as the creation of the nodes is an automatic process, account permissions and security must be taken into account. Some assets, although relevant, may not be accessible to all users, or may be confidential.

In one embodiment, temporal associations 312 between assets 310 may be created by first determining if a set of assets are associated based on the search criteria from the user, and then by locating the temporal attributes of the associated assets to understand the temporal relationship between the assets. Resource Description Framework (RDF) may be used to access the assets where they are stored and extract their temporal attributes. As previously mentioned, the temporal attributes may be stored in an abstraction layer and not with the asset. In this case, XML metadata links the temporal attributes with the asset. RDF may also be used to extract the temporal attribute information in XML from the abstraction layer. This process may be performed following all of the assets returned by a search to show the full temporal associations. The results can be stored as their own “asset” for future reference in the abstraction layer, or it can be returned to the requester.

Assets 310 in the search result set and their temporal associations 312 are displayed in client interface 304, such as within a Web page or an application's graphical user interface (GUI). Temporal associations 312 may be displayed to the user using graph theory or other visualization techniques. For example, a visualization tool, such as HTML or a Knowledge Network, may be used to represent the temporal associations and first order connections. The results may also be displayed simply using a textual representation. RDF and Really Simple Syndication (RSS) may also be placed in front of the search results to provide input into other applications. In addition, filtered views may also be used to represent the associations and connections.

To identify a path through the information that another user has taken, the user may initiate a search query which returns assets which are related to the search criteria. All activity is stored in the metadata database, such as datastores 306 or index 308. This activity may include metadata about the user, the time of the search, link to a previous result, the query, and the results are stored in a database. Thus, the associations between the related assets, including the temporal associations, may be stored for the user, as well as the paths the user took through the information. If another user then selects to view this stored information in order to follow the trail of the user's search through the information, the trail the first user took may be displayed to the second user, who may then follow the trail of links that are part of the result set.

To determine the path that a previous user has taken, a query is performed on the metadata database for that user. A map may be built based on the user information, the time of the search, and the results of the search. This mapping is then stored in datastores 306 or index 308 to create a “trail of information” for the path the user has taken to locate information. Thus, the previous user's path through the search may be determined by viewing the stored trail, or implied by using text analytic techniques on the query to see if the searches were related.

FIG. 4 is a diagram illustrating an exemplary temporal path across related assets. Temporal association path 400 is represented in the illustrative example by a dashed line. FIG. 4 represent assets that are associated with each other, and the lines represent the temporal relationships. An asset is related to another asset if the asset references another asset or if the asset is derived from the other asset. The dashed line represents a path that a user takes through the assets.

In this illustrative example, a related set of assets comprises asset 1 402, asset 2 404, asset 3 406, asset 4 408, asset 6 410, and asset 7 412. The time attributes of each asset in the result set is identified. For example, the time attribute for asset 1 402 is time n 414, time n+m 416 for asset 2 404, time n+j 418 for asset 4 408, and time n+d 420 for asset 7 412. The time attributes for asset 1 402, asset 2 404, asset 4 408 and asset 7 412 linked together by a search path are then used to create a temporal association between the assets in the path. Temporal association path 400 in this example illustrates how asset 1 402, asset 2 404, asset 4 408 and asset 7 412 are related over time. These temporal relationships may then be provided to the user in any textual or graphical manner.

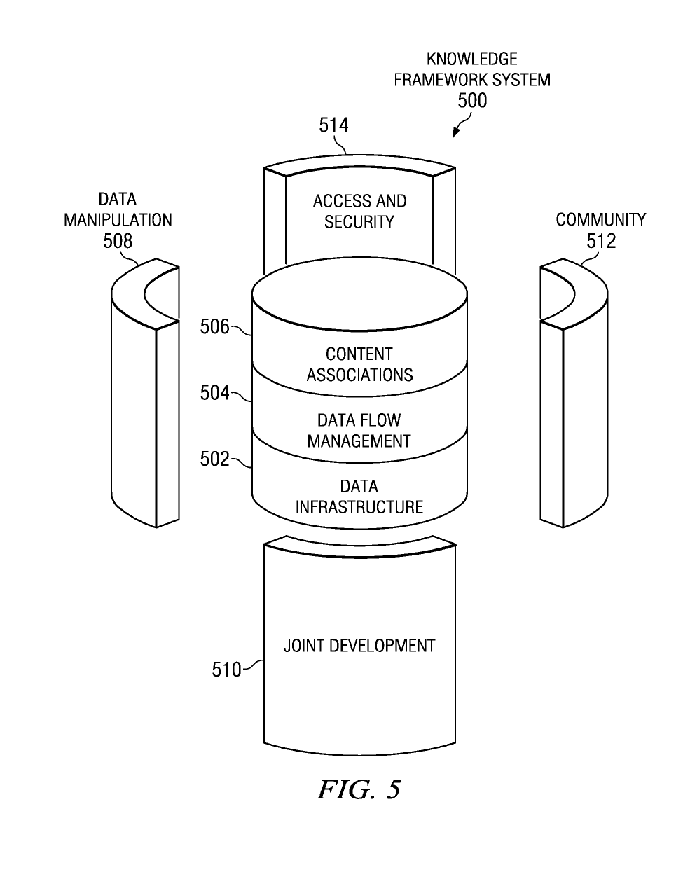

FIG. 5 is a diagram illustrating an infrastructure view of an exemplary knowledge framework system for linking together and providing associations in accordance with the illustrative embodiments. Knowledge framework system is an example of one framework system in which the temporal associations may be used to show a time relationship between related assets in a knowledge network, but it should be noted that any database or content management system may be used to implement the features described in the illustrative embodiments. Knowledge framework system 500, as described in U.S. Published Application 2006/0167890, is herein incorporated by reference.

Knowledge framework system 500 comprises a plurality of server/databases, and each server/database includes a data management infrastructure 502 layer for managing content within the server/database. Data flow management tool infrastructure 504 layer controls the content flow within and between each of the knowledge framework systems. Content association tool infrastructure 506 layer links together and provides associations (e.g., metadata) for the content within the knowledge framework systems. The associations allow associated content from the knowledge framework systems to be linked together so that a user may use the associations to search for and locate the associated content. The associations provide a map to locate the associated content from the knowledge framework systems. Data manipulation tool infrastructure 508 layer allows teams within an organization to create, modify, and promote different types of content within the knowledge framework system. Joint development tool infrastructure 510 layer allows different teams within the organization to leverage knowledge and technology regarding the content within the content framework system. Community tool infrastructure 512 layer allows different teams within an organization to collaborate and add value to the content within the content framework system. Access and Security tool infrastructure 514 layer allow administrators of the knowledge framework system the ability to control parties (i.e., users) who may access or manipulate content within the content framework system.

Assets may be stored in data management infrastructure 502 layer. The assets may be managed in data flow management tool infrastructure 504 layer. The relationships between the assets, including temporal associations, may be stored and created in the content association tool infrastructure 506 layer.

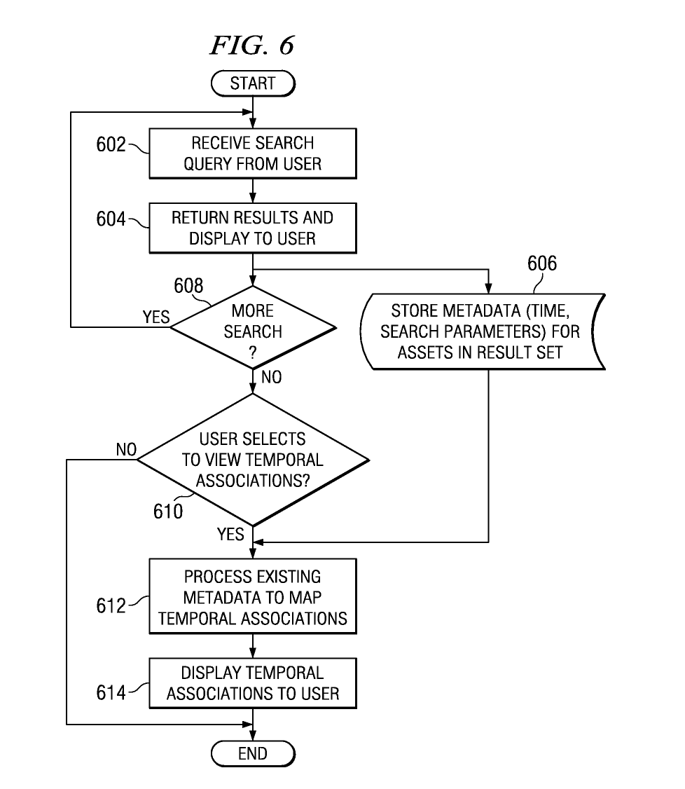

FIG. 6 is a flowchart of a process for establishing temporal associations between assets within a knowledge network in a plurality of datastores in accordance with the illustrative embodiments. The process depicted in FIG. 6 may be implemented in data processing system 300 in FIG. 3.

The process begins with receiving a search request from a user, wherein the search request comprises a query string to locate a set of assets matching the query (step 602). Based on the criteria in the query string, a result set is returned to the user for viewing (step 604). The query results may be based on a textual match, a contextual match, or any other methods of matching results to a query request. In addition, metadata for the returned results are stored in a metadata database, such as, for example, datastores 306 or index 308 in FIG. 3 (step 606). The metadata may include the time of creation of the asset, last modification time of the asset, search parameters for contextual matching, the requester, the requestor's search parameters, and resulting information, among others.

A determination is then made as to whether the user has selected to perform a new search query (step 608). If the user continues searching (‘yes’ output of step 608), the process loops back to step 602. In this situation, additional metadata will be stored for the user's subsequent search as shown in step 606. If the user does not continue searching (‘no’ output of step 608), a determination is made as to whether the user has requested to view the temporal associations between the assets in the result set (step 610).

If the user has not requested to view the temporal associations (‘no’ output of step 610), the process terminates thereafter. If the user has requested to view the temporal associations of the assets in the result set (‘yes’ output of step 610), the metadata comprising the time attributes stored in step 606 for each asset in the result set are queried to obtain and create the temporal associations between the assets (step 612). The temporal associations may then be displayed to the user (step 614) using a technique such as graph theory, with the process terminating thereafter.

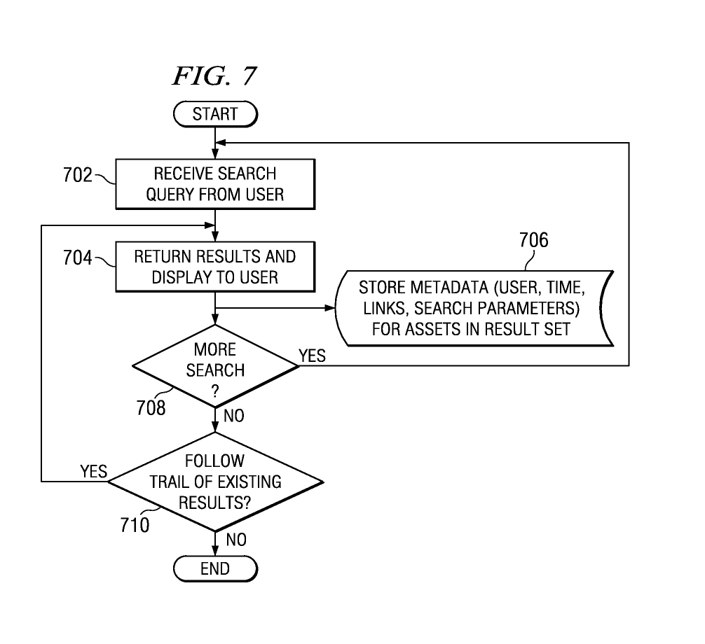

FIG. 7 is a flowchart of a process for determining the path a user took to locate information and for researching information in accordance with the illustrative embodiments. The process depicted in FIG. 7 may be implemented in data processing system 300 in FIG. 3. The process begins with receiving a search request from a user, wherein the search request comprises a query string to locate a set of assets matching the query (step 702). A user may perform searches at any time. Based on the criteria in the query string, a result set is returned to the user for viewing (step 704). All activity is stored in the metadata database. For example, metadata about the user, the time of the search, links to the previous result, the search query, and the result set are stored in a metadata database, such as, for example, datastores 306 or index 308 in FIG. 3 (step 706).

Each selection by the user is also stored in the metadata database. A determination is made as to whether the user has selected to perform a new search query (step 708). If the user continues searching (‘yes’ output of step 708), the process loops back to step 702. If the user does not continue searching (‘no’ output of step 708), a determination is made as to whether the user has selected to follow the trail of existing search results which are part of the current result set (step 710). If the user has not selected to follow the trail of existing search results (‘no’ output of step 710), the user ends the search, with the process terminating thereafter.

If the user selects to follow the trail of existing search results (‘yes’ output of step 710), the process returns to step 704 in which the trail results are displayed to the user. The user may then follow the stored trail of a user to locate information in the result set.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for preserving temporal associations between assets located across a plurality of datastores in a network, the computer implemented method comprising:
storing metadata about each asset located in the plurality of datastores, wherein the metadata includes one or more time attributes of each asset;
creating temporal associations between the assets using the time attributes of each asset; and
storing the temporal associations between the assets.

2. The computer implemented method of claim 1, further comprising:
responsive to receiving a request from a user to view a set of assets, displaying the temporal associations of the set of assets to the user.

3. The computer implemented method of claim 2, wherein the temporal associations are displayed using a graph theory technique or other graphical representation of the temporal associations, or as a textual representation.

4. The computer implemented method of claim 2, wherein the request comprises a query string to locate the set of assets matching the request.

5. The computer implemented method of claim 2, wherein the temporal associations are displayed to the user upon request.

6. The computer implemented method of claim 2, wherein the temporal associations displayed to the user comprise links to associated assets.

7. The computer implemented method of claim 1, wherein creating the temporal associations further comprises creating temporal associations between assets that are related by content.

8. The computer implemented method of claim 1, wherein creating the temporal associations further comprises creating temporal associations between assets that are traversed by a user.

9. The computer implemented method of claim 1, wherein the time attributes include at least one of a creation time, stored time, or last modification time of each asset.

10. The computer implemented method of claim 1, wherein a temporal association is one of a static relationship between the set of assets at a time the temporal association is created or a dynamic relationship which allows the time attributes to change and is based on a user's path through the set of assets.

11. The computer implemented method of claim 1, wherein the time attributes for each asset are tagged within the asset directly or tagged at a location where the asset is stored.

12. The computer implemented method of claim 11, wherein tagging of the time attributes is performed using Semantic Web or similar metadata constructs.

13. A computer implemented method for determining a path a first user has taken to locate information across a plurality of datastores in a network, the computer implemented method comprising:
storing metadata about each asset located across the plurality of datastores, wherein the metadata includes a time attribute, a user attribute, and a trail traversed by a first user through information in the datastores;
creating temporal associations between the assets in the plurality of datastores using the time attributes of each asset; and
responsive to a selection by a second user to follow the path traversed by the first user, providing the trail to the second user, wherein the second user may use links in the trail to follow a path that the first user has taken to locate information in the plurality of datastores.

14. A data processing system for preserving temporal associations between assets located across a plurality of datastores in a network, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to store metadata about each asset located in the plurality of datastores, wherein the metadata includes one or more time attributes of each asset, create temporal associations between the assets using the time attributes of each asset; and store the temporal associations between the assets.

15. The data processing system of claim 14, wherein the processing unit further executes the computer usable code to display the temporal associations of a set of assets to a user in response to receiving a request from the user to view the set of assets.

16. The data processing system of claim 15, wherein the temporal associations are displayed using a graph theory technique or other graphical representation of the temporal associations, or as a textual representation.

17. The data processing system of claim 15, wherein the request comprises a query string to locate the set of assets matching the request.

18. The data processing system of claim 15, wherein the temporal associations displayed to the user comprise links to associated assets.

19. The data processing system of claim 14, wherein the computer usable code to create the temporal associations further comprises creating temporal associations between assets that are related by content.

20. The data processing system of claim 14, wherein the computer usable code to create the temporal associations further comprises creating temporal associations between assets that are traversed by a user.

21. The data processing system of claim 14, wherein the time attributes include at least one of a creation time, stored time, or last modification time of each asset.

22. The data processing system of claim 14, wherein a temporal association is one of a static relationship between the set of assets at a time the temporal association is created or a dynamic relationship which allows the time attributes to change and is based on a user's path through the set of assets.

23. The data processing system of claim 14, wherein the time attributes for each asset are tagged within the asset directly or tagged at a location where the asset is stored.

24. A computer program product for preserving temporal associations between assets located across a plurality of datastores in a network, the computer program product comprising:
a computer usable medium having computer usable program code tangibly embodied thereon, the computer usable program code comprising:
computer usable program code for storing metadata about each asset located in the plurality of datastores, wherein the metadata includes one or more time attributes of each asset;
computer usable program code for creating temporal associations between the assets using the time attributes of each asset; and
computer usable program code for storing the temporal associations between the assets.

25. The computer program product of claim 24, further comprising:
computer usable program code for displaying the temporal associations of a set of assets to a user in response to receiving a request from the user to view the set of assets.

26. The computer program product of claim 25, wherein the temporal associations are displayed using a graph theory technique or other graphical representation of the temporal associations, or as a textual representation.

27. The computer program product of claim 25, wherein the request comprises a query string to locate the set of assets matching the request.

28. The computer program product of claim 25, wherein the temporal associations are displayed to the user upon request.

29. The computer program product of claim 25, wherein the temporal associations displayed to the user comprise links to associated assets.

30. The computer program product of claim 24, wherein computer usable program code for creating the temporal associations further comprises creating temporal associations between assets that are related by content.

31. The computer program product of claim 24, wherein computer usable program code for creating the temporal associations further comprises creating temporal associations between assets that are traversed by a user.

32. The computer program product of claim 24, wherein the time attributes include at least one of a creation time, stored time, or last modification time of each asset.

33. The computer program product of claim 24, wherein a temporal association is one of a static relationship between the set of assets at a time the temporal association is created or a dynamic relationship which allows the time attributes to change and is based on a user's path through the set of assets.

34. The computer program product of claim 24, wherein the time attributes for each asset are tagged within the asset directly or tagged at a location where the asset is stored.

35. The computer program product of claim 34, wherein tagging of the time attributes is performed using Semantic Web or similar metadata constructs.
